(19) United States
(12) Patent Application Publication
(10) Pub. No.: US 2016/0103523 A1
(43) Pub. Date: Apr. 14, 2016

(54) TOUCH DEVICE AND TOUCH DISPLAY DEVICE

(71) Applicant: InnoLux Corporation, Miao-Li County (TW)

(72) Inventors: Yang-Chen CHEN, Miao-Li County (TW); Chia-Hsiung CHANG, Miao-Li County (TW); Kuei-Ling LIU, Miao-Li County (TW)

(21) Appl. No.: 14/877,363

(22) Filed: Oct. 7, 2015

(30) Foreign Application Priority Data
Oct. 9, 2014 (CN) 201420580553.4

(51) Int. Cl. G06F 3/044; G09G 3/36; G06F 3/041

(52) U.S. Cl. CPC G06F 3/044; G06F 3/0412; G09G 3/3648; G06F 2203/04112; G06F 2203/04103

(57) ABSTRACT

A touch device comprises a substrate, a plurality of sensing electrodes and a plurality of dummy electrodes. The sensing electrodes are disposed on the substrate. The dummy electrodes disposed on the substrate and between the sensing electrodes. The dummy electrodes are disposed separately by a plurality of trenches which are disposed across each other. An intersection of the trenches is configured with at least one first protrusion. Because of the first protrusion disposed at the intersection of the trenches, the corona discharge occurring at the dummy electrode can be reduced and the electrical performance of the touch device won't be deteriorated. Besides, the disposition of the first protrusion can blur the edge of the dummy electrode, so that human eyes will uneasily perceive the dummy electrode and the display performance of the touch device can be enhanced.

### CROSS REFERENCE TO RELATED APPLICATIONS

This Non-provisional application claims priority under 35 U.S.C. §119(a) on Patent Application No(s). 201420580553.4 filed in People's Republic of China on Oct. 9, 2014, the entire contents of which are hereby incorporated by reference.

### BACKGROUND OF THE INVENTION

1. Field of Invention

This invention relates to a touch device and a touch display device.

2. Related Art

With the progress of technologies, various novel information devices are invented, such as cell phones, tablet computers, ultrabooks and GPS (global positioning system) navigation devices. Generally, a keyboard and mouse are commonly used to manipulate the information device for inputting information. Besides, the touch control technology currently also becomes a popular manipulation method for the information device and brings an intuitive operation. Accordingly, a touch display device using the touch control technology can provide a friendly and intuitive interface for the input operation, and therefore users of all ages can manipulate the touch display device by fingers or a stylus. Accordingly, touch devices have been given more and more affection in the market.

Generally, the touch structure of a touch device comprises a patterned portion of electrode and a patterned portion of non-electrode. The patterned portion of electrode is the region with conducting material and the patterned portion of non-electrode is the hollowed region without conducting material. Since the disposition of the conducting material results in that the patterned portion of electrode and the patterned portion of non-electrode have different refractive indexes, human eyes will easily perceive the electrode pattern and the display performance will be influenced therefore.

In order to solve the above problem, a floating dummy electrode is added in the patterned portion of non-electrode. That is, the conducting material that is the same as the material of the patterned portion of electrode is filled into the hollowed region so as to decrease the area of the hollowed region. However, the point discharge phenomenon easily occurs at the corner of the bulk-like or strip-like dummy electrode, so that the electrical performance of the touch device is influenced.

### SUMMARY OF THE INVENTION

An objective of this disclosure is to provide a touch device and a touch display device to solve the problem of the corona discharge easily occurring at the corner of the dummy electrode when the conducting material that is the same as the material of the patterned portion of electrode is filled into the hollowed region.

A touch device of this embodiment comprises a substrate, a plurality of sensing electrodes and a plurality of dummy electrodes. The sensing electrodes are disposed on the substrate. The dummy electrodes disposed on the substrate and between the sensing electrodes. The dummy electrodes are disposed separately by a plurality of trenches which are disposed across each other. An intersection of the trenches is configured with at least one first protrusion.

In one embodiment, the trenches comprise a plurality of first trenches and a plurality of second trenches, the first trenches are disposed along a first direction and the second trenches are disposed along a second direction.

In one embodiment, the first protrusion comprises a bevel edge, and the bevel edge connects to a first side of the first trench and a second side of the second trench which intersect each other.

In one embodiment, the greatest distance between the two adjacent first protrusions is larger than the distance between two sides of the second trench.

In one embodiment, the first trench and the second trench comprise at least a second protrusion, which is disposed on at least one of the first side and the second side and disposed adjacent to the first protrusion.

In one embodiment, the distance between the opposite second protrusions respectively on two sides of the second trench is larger than the distance between the two sides of the second trench.

In one embodiment, the greatest distance between the two adjacent first protrusions is larger than the greatest distance between the opposite second protrusions of the second trench.

In one embodiment, the first trench and the second trench further comprise at least a third protrusion disposed at the bevel edge.

A touch display device of this embodiment comprises a substrate, a backlight module, a liquid crystal layer, a color filter, a thin film transistor (TFT) layer, a first polarizer, a second polarizer, a plurality of sensing electrodes and a plurality of dummy electrodes. The backlight module is disposed opposite to the substrate. The liquid crystal layer is disposed between the substrate and the backlight module. The color filter is disposed between the substrate and the backlight module. The thin film transistor (TFT) layer is disposed between the substrate and the backlight module. The first polarizer is disposed on side of the substrate farther from the backlight module. The second polarizer is disposed between the substrate and the backlight module. The sensing electrodes are disposed on the substrate. The dummy electrodes are disposed on the substrate and between the sensing electrodes and disposed separately by a plurality of trenches which are disposed across each other. An intersection of the trenches is configured with at least one first protrusion.

As mentioned above, the intersection of the trenches of the touch device of this invention is configured with the first protrusion, so that the corona discharge occurring at the dummy electrode can be reduced and the electrical performance of the touch device won't be deteriorated. Besides, the disposition of the first protrusion can blur the edge of the dummy electrode, so that human eyes will uneasily perceive the dummy electrode and the display performance of the touch device can be enhanced.

### BRIEF DESCRIPTION OF THE DRAWINGS

The embodiments of the invention will become more fully understood from the detailed description and accompanying drawings, which are given for illustration only, and thus are not limitative of the present invention, and wherein:

FIG. 1A is a schematic diagram of a touch device of an embodiment of the invention;

FIG. 1B is a schematic top view of the touch device of FIG. 1A;

FIG. 2 is a schematic enlarged diagram of a part of the region A of FIG. 1B according to an embodiment of the invention;

FIG. 3 is a schematic enlarged diagram of a part of the region A of FIG. 1B according to another embodiment of the invention;

FIG. 4 is a schematic diagram showing multiple variations of the first protrusion of FIG. 2; and

FIG. 5 is a schematic enlarged diagram of the region A of FIG. 1B according to another embodiment of the invention.

### DETAILED DESCRIPTION OF THE INVENTION

The embodiments of the invention will be apparent from the following detailed description, which proceeds with reference to the accompanying drawings, wherein the same references relate to the same elements.

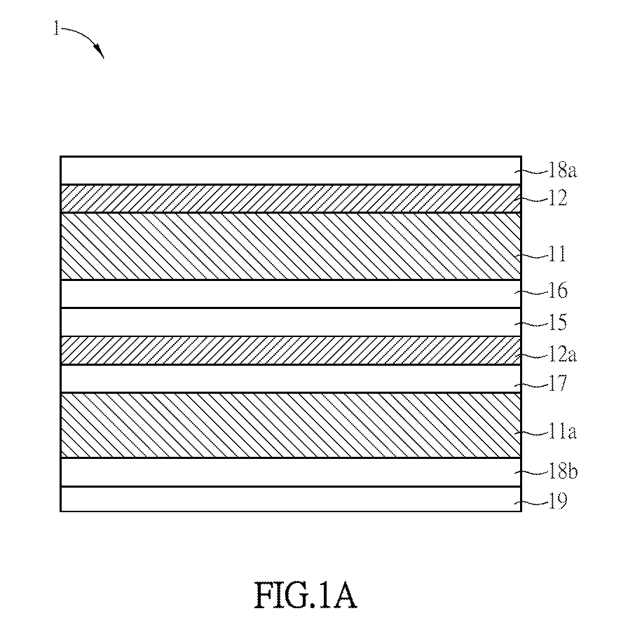

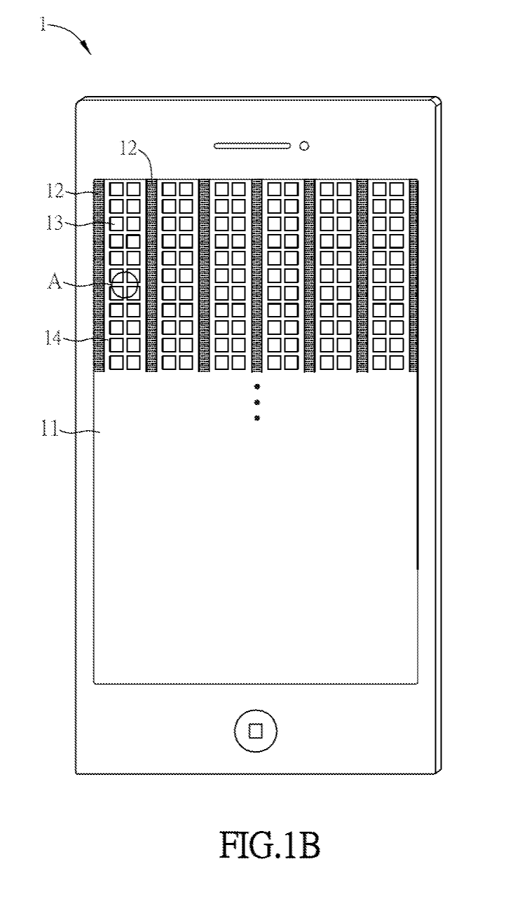

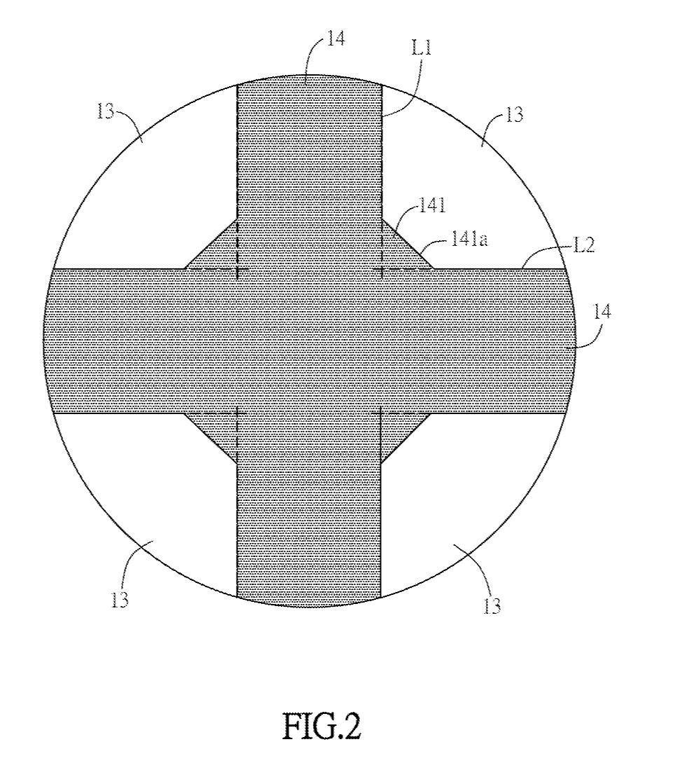

FIG. 1A is a schematic diagram of a touch device of an embodiment of the invention, FIG. 1B is a schematic top view of the touch device of FIG. 1A, and FIG. 2 is a schematic enlarged diagram of a part of the region A of FIG. 1B according to an embodiment of the invention. As shown in FIGS. 1A, 1B and 2, the touch device 1 can be a smart phone, a tablet computer, a PDA (personal digital assistant), a notebook computer or a wearable device for example. The touch device 1 comprises a substrate 11, a plurality of sensing electrodes 12, a plurality of dummy electrodes 13 and a plurality of trenches 14. The substrate 11 can be a glass substrate, a plastic substrate, a flexible substrate, a sapphire substrate, a polarizer, or a layer of a display panel. The sensing electrodes 12 are disposed on the substrate 11, and the dummy electrodes 13 are disposed on the substrate 11 and between the sensing electrodes 12. The dummy electrodes 13 are not connected with the sensing electrodes 12. The dummy electrodes 13 are electrically floating. Herein, the dummy electrodes 13 are disposed separately by the trenches 14 which are disposed across each other.

In this embodiment, the sensing electrodes 12 are disposed along an axis and the dummy electrodes 13 may be also disposed along the axis. In the embodiment, the sensing electrodes 12 and the dummy electrodes 13 are disposed alternately on the substrate 11. The touch device 1 further comprises another substrate 11a, which is disposed corresponding to the substrate 11 and configured with the sensing electrodes 12a disposed along another axis. The two axes may differ by 90 degrees. In other embodiments, the sensing electrodes 12 may be disposed along two axes, and can be disposed on the same side of the substrate 11 or on the different two sides of the substrate 11 respectively. However, this invention is not limited thereto.

The touch device 1 of this embodiment further comprises a liquid crystal layer 15, a color filter 16, a thin film transistor (TFT) layer 17, a first polarizer 18a, a second polarizer 18b and a backlight module 19. The liquid crystal layer 15 is disposed between the substrates 11 and 11a. The color filter 16 is disposed on the side of the substrate 11 facing the substrate 11a. In another embodiment, the color filter 16 may be disposed on the substrate 11a. The TFT layer 17 is disposed between the substrate 11a and the sensing electrodes 12a. The first polarizer 18a is disposed on the side of the sensing electrodes 12 farther from the substrate 11. The second polarizer 18b is disposed on the side of the substrate 11a farther from the liquid crystal layer 15. The backlight module 19 is disposed on the side of the second polarizer 18b farther from the substrate 11a. In other words, the touch device 1 of this embodiment and the display module are integrated to form a touch display device. The positions thereof can be adjusted according to the requirement, and this disclosure is not limited thereto.

This embodiment is illustrated as below, for example, by using the relationship among the sensing electrodes 12, the dummy electrodes 13 and the trenches 14 on the substrate 11. Moreover, the substrate 11a and the sensing electrodes 12a can have the same structures as the substrate 11 and the sensing electrodes 12 respectively, but this invention is not limited thereto.

In this embodiment, the trenches 14 comprise a plurality of first trenches 14a and a plurality of second trenches 14b. The first trenches 14a and the second trenches 14b are disposed across each other and between the dummy electrodes 13. In other words, the dummy electrodes 13 are disposed separately by the trenches 14 which are disposed across each other. The first trenches 14a are disposed along a first direction and the second trenches 14b are disposed along a second direction, so that they are disposed across each other and configured to an intersection. The intersection of the first trench 14a and the second trench 14b is configured with a first protrusion 141. To be noted, the first protrusion 141 refers to the shape of the intersection of the first trench 14a and the second trench 14b. By taking FIG. 2 as an example, the first protrusion 141 protrudes at the intersection of the trenches 14 and on the plane formed by the first direction and the second direction, and has a triangle-like shape with two edges originating from the intersected extension lines of the two trenches 14. In other words, the first protrusion 141 is a concave portion of the dummy electrode 13. Therefore, in comparison with the trenches without the protrusion, the dummy electrode 13 of this embodiment, i.e. the trenches with the protrusion, will be less subjected to the corona discharge at the intersection of the trenches 14, so that the electrical performance of the touch device 1 won't be deteriorated. Besides, the disposition of the first protrusion 141 can blur the edge of the dummy electrode 13, so that human eyes will uneasily observe the dummy electrode 13 and the display performance of the touch device 1 can be enhanced.

In this embodiment, the first trench 14a has a first side L1 and a third side L3 opposite to the first side L1, and the second trench 14b has a second side L2 and a forth side L4 opposite to the second side L2. The first side L1 and the second side L2 intersect at an angle larger than 0 degree and less than 180 degrees. The first protrusion 141 comprises a bevel edge 141a. The bevel edge 141a connects to the first side L1 of the first trench 14a and the second side L2 of the second trench 14b, and the bevel edge 141a is a substantially straight line for example. That is, the bevel edge 141a is the third edge of the triangular shape of the first protrusion 141. Moreover, the number of the first protrusion 141 of this embodiment is not limited, and there may be one or more first protrusions 141. For example, there are four first protrusions 141 in FIG. 2.

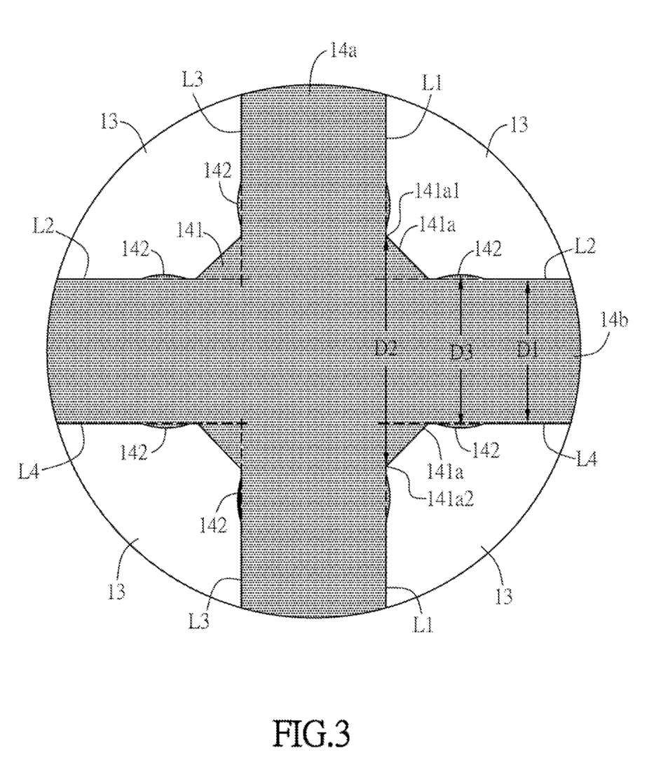

FIG. 3 is a schematic enlarged diagram of a part of the region A of FIG. 1B according to another embodiment of the invention. As shown in FIG. 3, in this embodiment, the first trench 14a or the second trench 14b comprises at least a second protrusion 142. In FIG. 3, the second protrusions 142 are respectively disposed on two sides of the first trench 14a and the second trench 14b, and are disposed adjacent to the first protrusions 141, but this invention is not limited thereto. The second protrusion may be disposed at different position depending on the design requirement. To be noted, the second protrusion 142 refers to the shape of the first trench 14a or the second trench 14b. By taking FIG. 3 as an example, the second protrusion 142 slightly protrudes from a side of each of the first trench 14a and the second trench 14b and on the plane formed by the first direction and the second direction, and the area of the second protrusion 142 is less than that of the first protrusion 141. Therefore, the layout of the second protrusion 142 can blur the edge of the dummy electrode 13, so that human eyes will uneasily perceive the dummy electrode 13 and the display performance of the touch device 1 can be enhanced. Moreover, the first protrusion 141 and the second protrusion 142 are disposed separately in this embodiment, but they may be disposed adjacent to each other in other embodiments.

As shown in FIG. 3, in this embodiment, the distance between the two sides L2 and L4 of the second trench 14b is defined as D1, and the greatest distance between the two adjacent first protrusions 141 is defined as D2. It means the distance D2 is calculated from a first joint 141a1 of the bevel edge 141a of the first protrusion 141 and the first side L1 of the first trench 14a to a second joint 141a2 of the bevel edge 141a of the adjacent first protrusion 141 and the first side L1 of the first trench 14a is defined as D2. When the touch device 1 comprises a plurality of first protrusions 141, the distance D2 is larger than the distance D1. Moreover, when the touch device 1 comprises a plurality of second protrusions 142, the greatest distance between the opposite second protrusions 142 on the two sides of the second trench 14b is defined as D3. The distance D3 is larger than the distance D1 and less than the distance D2. In other words, the distance D3 is between the distance D1 and the distance D2 in magnitude.

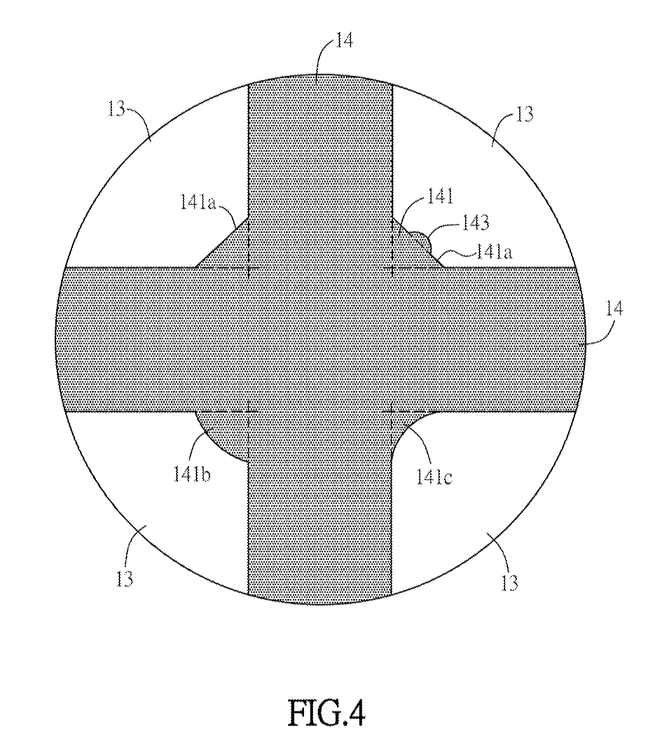

FIG. 4 is a schematic diagram showing multiple variations of the first protrusion of FIG. 2. As shown in FIG. 4, the first protrusion 141 can be varied according to the requirement of the product design. For example, the first protrusion 141 at the upper left intersection of the first trench 14a and the second trench 14b comprises a bevel edge 141a. Since the illustration of the bevel edge 141a can be comprehended by referring to the above embodiments, the related description is omitted here for conciseness. The first protrusion 141b at the lower left comprises a curved surface bulging from the intersection of the first trench 14a and the second trench 14b to the dummy electrode 13. Contrarily, the first protrusion 141c at the lower right comprises a curved surface concaved towards the intersection of the first trench 14a and the second trench 14b. Furthermore, the intersection of the first trench 14a and the second trench 14b can further comprise at least a third protrusion 143, which is disposed at the bevel edge 141a and protrudes form the bevel edge 141a, as shown on the upper right side of FIG. 4.

In the above embodiments, the first direction and the second direction along which the first trench 14a and the second trench 14b are respectively extended are substantially perpendicular to each other. However, this invention is not limited thereto. In other embodiments, the extension directions of the first trench 14a and the second trench 14b may be not perpendicular to each other.

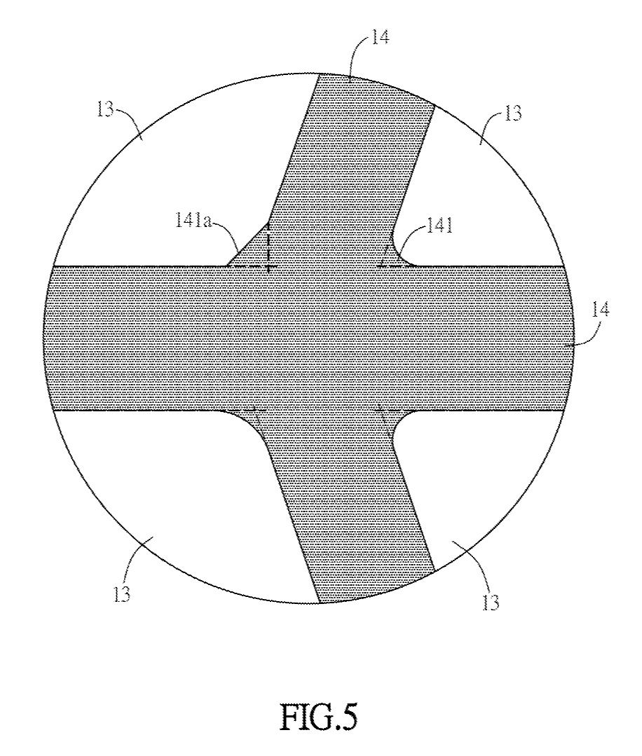

FIG. 5 is a schematic enlarged diagram of the region A of FIG. 1B according to another embodiment of the invention. As shown in FIG. 5, in this embodiment, the trenches 14 are respectively extended along a third direction, a fourth direction and a fifth direction. The third direction, the fourth direction and the fifth direction are not perpendicular to each other. Likewise, in this embodiment, each of the intersections of the trenches 14 is configured with a first protrusion 141, so as to reduce the corona discharge occurring at the dummy electrode 13. Besides, the first protrusion 141 also can comprise a bevel edge 141a, and the related descriptions can be comprehended by referring to the above embodiments and are thus omitted here for conciseness.

Summarily, the intersection of the trenches of the touch device of this invention is configured with the first protrusion, so that the corona discharge occurring at the dummy electrode can be reduced and the electrical performance of the touch device won't be deteriorated. Besides, the disposition of the first protrusion can blur the edge of the dummy electrode, so that human eyes will uneasily perceive the dummy electrode and the display performance of the touch device can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch device, comprising:
a substrate;
a plurality of sensing electrodes disposed on the substrate; and
a plurality of dummy electrodes disposed on the substrate and between the sensing electrodes and disposed separately by a plurality of trenches which are disposed across each other,
wherein an intersection of the trenches is configured with at least one first protrusion.

2. The touch device as recited in claim 1, wherein the trenches comprise a plurality of first trenches and a plurality of second trenches, the first trenches are disposed along a first direction and the second trenches are disposed along a second direction.

3. The touch device as recited in claim 2, wherein the first protrusion comprises a bevel edge, and the bevel edge connects to a first side of the first trench and a second side of the second trench which intersect each other.

4. The touch device as recited in claim 3, wherein the greatest distance between the two adjacent first protrusions is larger than the distance between two sides of the second trench.

5. The touch device as recited in claim 3, wherein the first trench and the second trench comprise at least a second protrusion, which is disposed on at least one of the first side and the second side and disposed adjacent to the first protrusion.

6. The touch device as recited in claim 5, wherein the distance between the opposite second protrusions respectively on two sides of the second trench is larger than the distance between the two sides of the second trench.

7. The touch device as recited in claim 6, wherein the greatest distance between the two adjacent first protrusions is larger than the greatest distance between the opposite second protrusions of the second trench.

8. The touch device as recited in claim 3, wherein the first trench and the second trench further comprise at least a third protrusion disposed at the bevel edge.

9. A touch display device, comprising:
a substrate;
a backlight module disposed opposite to the substrate:
a liquid crystal layer disposed between the substrate and the backlight module;
a color filter disposed between the substrate and the backlight module;
a thin film transistor (TFT) layer disposed between the substrate and the backlight module;
a first polarizer disposed on side of the substrate farther from the backlight module;
a second polarizer disposed between the substrate and the backlight module;
a plurality of sensing electrodes disposed on the substrate; and
a plurality of dummy electrodes disposed on the substrate and between the sensing electrodes and disposed separately by a plurality of trenches which are disposed across each other,
wherein an intersection of the trenches is configured with at least one first protrusion.

10. The touch display device as recited in claim 9, wherein the trenches comprise a plurality of first trenches and a plurality of second trenches, the first trenches are disposed along a first direction and the second trenches are disposed along a second direction.

11. The touch display device as recited in claim 10, wherein the first protrusion comprises a bevel edge, and the bevel edge connects to a first side of the first trench and a second side of the second trench which intersect each other.

12. The touch display device as recited in claim 11, wherein the greatest distance between the two adjacent first protrusions is larger than the distance between two sides of the second trench.

13. The touch display device as recited in claim 11, wherein the first trench and the second trench comprise at least a second protrusion, which is disposed on at least one of the first side and the second side and disposed adjacent to the first protrusion.

14. The touch display device as recited in claim 13, wherein the distance between the opposite second protrusions respectively on two sides of the second trench is larger than the distance between the two sides of the second trench.

15. The touch display device as recited in claim 14, wherein the greatest distance between the two adjacent first protrusions is larger than the greatest distance between the opposite second protrusions of the second trench.

16. The touch display device as recited in claim 11, wherein the first trench and the second trench further comprise at least a third protrusion disposed at the bevel edge.
